(19) United States
(12) Patent Application Publication
(10) Pub. No.: US 2026/0094578 A1
(43) Pub. Date: Apr. 2, 2026

(54) DATA DRIVING CIRCUIT, DRIVING METHOD OF DATA DRIVING CIRCUIT, AND DISPLAY DEVICE INCLUDING DATA DRIVING CIRCUIT

(71) Applicant: LG Display Co., Ltd., Seoul (KR)

(72) Inventor: Beomjin KIM, Paju-si (KR)

(73) Assignee: LG Display Co., Ltd., Seoul (KR)

(21) Appl. No.: 19/293,538

(22) Filed: Aug. 7, 2025

(30) Foreign Application Priority Data
Oct. 2, 2024 (KR) 10-2024-0133593

(51) Int. Cl. G09G 3/3291

(52) U.S. Cl. CPC G09G 3/3291; G09G 2300/0819; G09G 2310/027; G09G 2310/0297; G09G 2310/08

(57) ABSTRACT

The embodiments relate to a data driving circuit, a driving method for driving the data driving circuit, and a display device including the data driving circuit, wherein the data driving circuit includes a control circuit electrically connected to a sensing node in a pixel through a readout line, a multiplexer including an input terminal connected to the readout line and the control circuit, and configured to electrically connect either the readout line or the control circuit to an output terminal thereof based on a selection signal, and an analog-to-digital converter electrically connected to the output terminal of the multiplexer.

### CROSS-REFERENCE TO RELATED APPLICATION

The present application claims priority to Korean Patent Application No. 10-2024-0133593, filed on Oct. 2, 2024, the entire contents of which are incorporated herein for all purposes by this reference.

### BACKGROUND

### Technical Field

The present disclosure relates to a data driving circuit, a driving method of the driving the data driving circuit, and a display device including the data driving circuit.

### Description of the Related Art

The pixels of a display device include a light-emitting element and a driving circuit for driving the light-emitting element. The light-emitting element may vary depending on the type of display device, but recently, organic light-emitting diodes (OLEDs), which offer fast response times, high luminous efficiency, brightness, viewing angles, contrast ratios, and excellent color reproduction, have been actively used.

During the operation of the display device, the elements of the driving circuit may degrade. The degradation of elements reduces the brightness of the pixels. To prevent this issue, a compensation method that senses the characteristics of the components and compensates the data voltage based on the sensing results has been applied.

### BRIEF SUMMARY

The embodiments provide a data driving circuit, a driving method of the data driving circuit, and a display device including the data driving circuit, which are capable of sensing pixel characteristic values to compensate for degradation.

The embodiments provide a data driving circuit, a driving method of the data driving circuit, and a display device including the data driving circuit, which are capable of enabling both voltage-based and current-based pixel sensing, by equipping the data driving circuit with an operational amplifier, multiple switching elements connected to the operational amplifier, a sampling capacitor, a feedback resistor, a control circuit, and a multiplexer.

The embodiments provide a data driving circuit, a driving method of the data driving circuit, and a display device including the data driving circuit, which are capable of generating sensing data in a voltage-based pixel sensing mode by transmitting a sensing signal output from the pixel to an analog-to-digital converter.

The embodiments provide a data driving circuit, a driving method of the data driving circuit, and a display device including the data driving circuit, which are capable of generating sensing data in a current-based pixel sensing mode by transmitting a sensing signal output from the pixel to an operational amplifier operating as a current-to-voltage conversion circuit and then delivering the sensing voltage output from the operational amplifier to an analog-to-digital converter.

The embodiments provide a data driving circuit, a driving method of the data driving circuit, and a display device including the data driving circuit, which are capable of generating sensing data in a current-based pixel sensing mode by transmitting a sensing signal output from the pixel to an operational amplifier operating as a current integrator and then delivering the sensing voltage output from the operational amplifier to an analog-to-digital converter.

The embodiments provide a data driving circuit, a driving method of the data driving circuit, and a display device including the data driving circuit, which are capable of holding a sensing signal output from the pixel in a sampling capacitor for a predetermined period and then outputting the sensing signal to an analog-to-digital converter.

A data driving circuit according to an embodiment may include a control circuit electrically connected to a sensing node in a pixel through a readout line, a multiplexer including an input terminal connected to the readout line and the control circuit, and configured to electrically connect either the readout line or the control circuit to an output terminal thereof based on a selection signal, and an analog-to-digital converter electrically connected to the output terminal of the multiplexer.

The control circuit may include an operational amplifier connected between the readout line and the multiplexer, a plurality of switching elements connected to a first input terminal of the operational amplifier, a sampling capacitor connected to the first input terminal through one of the plurality of switching elements, and a feedback resistor connected to the first input terminal through another one of the plurality of switching elements.

The plurality of switching elements may include a first switching element connected between the readout line and a first node, and the multiplexer may be configured to electrically connect the readout line to the analog-to-digital converter when the first switching element is turned off.

The plurality of switching elements may further include a second switching element connected between the first node and an output terminal of the operational amplifier, a third switching element connected between the first node and the feedback resistor, and a sixth switching element connected between the first node and the first input terminal, wherein the feedback resistor may be connected between the third switching element and the output terminal of the operational amplifier.

The plurality of switching elements may further include a fourth switching element connected between a second node and the output terminal of the operational amplifier, and the sampling capacitor may be connected between the first node and the second node.

The plurality of switching elements may further include a fifth switching element connected between the second node and the first input terminal.

The operational amplifier may further include a second input terminal configured to receive a control circuit reference voltage.

The data driving circuit may further include an initialization switch connected between the readout line and a reference voltage, and a sampling switch connected between the readout line, the control circuit, and the multiplexer.

A method for driving a data driving circuit may include a first mode of sensing the voltage value of the sensing node, wherein the first mode may include turning on the initialization switch during a first period, turning off the initialization switch during a second period, and turning on the sampling switch during a third period. During the first to third periods, the first switching element may be turned off, and a first level of the selection signal may be applied to the multiplexer.

The method may further include a second mode of sensing the current value of the sensing node, wherein the second mode may include turning on the second switching element during a first period of the second mode, and turning off the second switching element during a second period of the second mode. During the first and second periods of the second mode, the sampling switch, the first switching element, the third switching element, and the sixth switching element may be turned on, and a second level of the selection signal, different from the first level, may be applied to the multiplexer.

The method may further include a third mode of sensing the current value of the sensing node, wherein the third mode may include turning on the first switching element and the second switching element during a first period of the third mode, turning off the second switching element during a second period of the third mode, and turning off the first switching element during a third period of the third mode. During the first to third periods of the third mode, the sampling switch, the fourth switching element, and the sixth switching element may be turned on, and a second level of the selection signal, different from the first level, may be applied to the multiplexer.

The method may further include a fourth mode of sensing the voltage value of the sensing node, wherein the fourth mode may include turning on the initialization switch, the sampling switch, the first switching element, and the fourth switching element during a first period of the fourth mode, turning off the initialization switch during a second period of the fourth mode, and turning off the first switching element and the fourth switching element, and turning on the second switching element during a third period of the fourth mode. During the first to third periods of the fourth mode, the fifth switching element may be turned on, and a first level of the selection signal may be applied to the multiplexer.

A display device according to an embodiment may include a display panel including a plurality of pixels arranged therein, a data driving circuit configured to apply a data voltage to the pixels, and a timing controller configured to control operation timing of the data driving circuit.

The data driving circuit may include a control circuit electrically connected to a sensing node in a corresponding pixel through a readout line, a multiplexer including an input terminal connected to the readout line and the control circuit, and configured to electrically connect either the readout line or the control circuit to an output terminal thereof based on a selection signal, and an analog-to-digital converter electrically connected to the output terminal of the multiplexer.

The timing controller may apply a control signal to the data driving circuit to initiate a sensing mode of sensing characteristic values of the pixels, and the control circuit may include an operational amplifier configured to operate differently based on the control signal.

The control circuit may include the operational amplifier connected between the readout line and the multiplexer, a plurality of switching elements connected to a first input terminal of the operational amplifier, a sampling capacitor connected to the first input terminal through one of the plurality of switching elements, and a feedback resistor connected to the first input terminal through another one of the plurality of switching elements.

The plurality of switching elements may include a first switching element connected between the readout line and a first node, and the multiplexer may be configured to electrically connect the readout line to the analog-to-digital converter when the first switching element is turned off.

The plurality of switching elements may further include a second switching element connected between the first node and an output terminal of the operational amplifier, a third switching element connected between the first node and the feedback resistor, and a sixth switching element connected between the first node and the first input terminal, wherein the feedback resistor may be connected between the third switching element and the output terminal of the operational amplifier.

The plurality of switching elements may further include a fourth switching element connected between a second node and the output terminal of the operational amplifier, and the sampling capacitor may be connected between the first node and the second node.

The plurality of switching elements may further include a fifth switching element connected between the second node and the first input terminal.

The operational amplifier may further include a second input terminal configured to receive a control circuit reference voltage.

The data driving circuit may further include an initialization switch connected between the readout line and a reference voltage, and a sampling switch connected between the readout line, the control circuit, and the multiplexer.

The timing controller may comprise: a compensation unit that determines and generates compensation values for the characteristic values of the pixels, based on sensing data obtained through sensing the pixels; and a memory that stores the compensation values generated by the compensation unit.

### BRIEF DESCRIPTION OF THE SEVERAL VIEWS OF THE DRAWINGS

FIG. 1 is a block diagram illustrating a configuration of a display device according to an embodiment;

FIG. 2 is a diagram illustrating sensing timing according to an embodiment;

FIG. 3 is a diagram illustrating the connection relationship between the pixel, source drive circuit, and timing controller according to an embodiment;

FIG. 4 is a circuit diagram illustrating the configuration of the control circuit according to an embodiment;

FIG. 5 is a timing diagram illustrating the voltage-based pixel sensing method according to the first embodiment;

FIGS. 6 to 8 are diagrams for explaining the pixel sensing method according to the embodiment of FIG. 5;

FIG. 9 is a timing diagram illustrating the voltage-based pixel sensing method according to the second embodiment;

FIGS. 10 to 12 are diagrams for explaining the pixel sensing method according to the embodiment of FIG. 9;

FIG. 13 is a timing diagram illustrating the current-based pixel sensing method according to the third embodiment;

FIGS. 14 to 16 are diagrams for explaining the pixel sensing method according to the embodiment of FIG. 13;

FIG. 17 is a timing diagram illustrating the current-based pixel sensing method according to the fourth embodiment; and

FIGS. 18 to 20 are diagrams for explaining the pixel sensing method according to the embodiment of FIG. 17.

### DETAILED DESCRIPTION

Hereinafter, embodiments will be described with reference to accompanying drawings. In the specification, when a component (or area, layer, part, etc.) is mentioned as being “on top of,” “connected to,” or “coupled to” another component, it means that it may be directly connected/coupled to the other component, or a third component may be placed between them.

The same reference numerals refer to the same components. In the drawings, the thickness, proportions, and dimensions of the components are exaggerated for effective description of the technical content. The expression “and/or” is taken to include one or more combinations that can be defined by associated components.

The terms “first,” “second,” etc., are used to describe various components, but the components should not be limited by these terms. The terms are used only for distinguishing one component from another component. For example, a first component may be referred to as a second component and, similarly, the second component may be referred to as the first component, without departing from the scope of the present disclosure. The singular forms are intended to include the plural forms as well unless the context clearly indicates otherwise.

The terms such as “below,” “lower,” “above,” “upper,” etc., are used to describe the relationship of components depicted in the drawings. The terms are relative concepts and are described based on the direction indicated on the drawing.

It will be further understood that the terms “comprises,” “has,” and the like are intended to specify the presence of stated features, numbers, steps, operations, components, parts, or a combination thereof but are not intended to preclude the presence or possibility of one or more other features, numbers, steps, operations, components, parts, or combinations thereof.

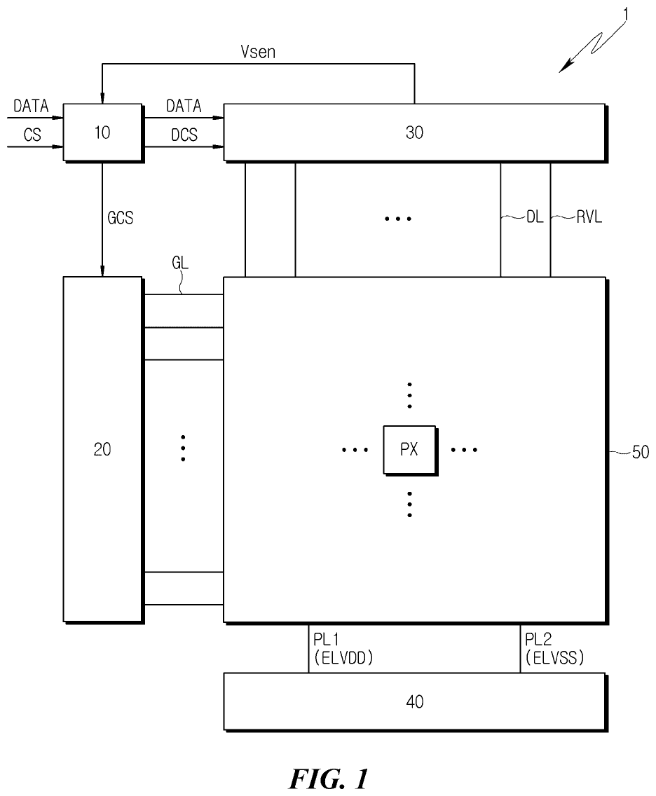

FIG. 1 is a block diagram illustrating a configuration of a display device according to an embodiment.

Referring to FIG. 1, the display device 1 includes the timing controller 10, gate driving circuit 20, data driving circuit 30, power supply unit 40, and display panel 50.

The timing controller 10 may control the operation timing of the gate driving circuit 20 and the data driving circuit 30. The timing controller 10 can receive the video signal RGB and control signal CS from an external host system or the like. The video signal RGB may include a plurality of grayscale data. The control signal CS may include, for example, horizontal sync signals, vertical sync signals, and the main clock signal.

The timing controller 10 processes the video signal RGB and control signal CS to match the operating conditions of the display panel 50, and may generate and output image data DATA, gate drive control signals GCS, and data drive control signals DCS. The control signal CS may include data enable signals, horizontal sync signals, vertical sync signals, and the main clock signal. The gate drive control signal GCS may include gate timing control signals such as the Gate Start Pulse, Gate Shift Clock, and Gate Output Enable signal. The data drive control signal DCS may include data timing control signals such as the Source Sampling Clock, Polarity, and Source Output Enable signal.

The timing controller 10 may be placed on a control printed circuit board connected to the source printed circuit board, on which the data driving circuit 30 is bonded, through a connection medium such as flexible flat cable (FFC) or flexible printed circuit (FPC). For example, the timing controller 10 may be connected to the data driving circuit 30 through embedded clock P-P interface (EPI) wire pairs to transmit and receive data.

The gate driving circuit 20 may generate gate signals based on the gate drive control signal GCS received from the timing controller 10. The gate driving circuit 20 may provide the generated gate signals to the pixels PX through a plurality of gate lines GL.

The gate driving circuit 20 may be configured in the form of a gate in panel mounted on the display panel 50. The gate driving circuit 20 may be positioned on one side of the display panel 50, or as illustrated, it may be placed on both sides of the display panel 50 (e.g., the left and right sides). Depending on the driving method, panel design, and the like, the gate driving circuit 20 may be placed on both sides of the display panel 50 (e.g., the left and right sides) as shown, or it may be connected to two or more sides of the four sides of the display panel 50.

The data driving circuit 30 may generate data signals based on the image data DATA and data driving control signals DCS output from the timing controller 10. The data driving circuit 30 may provide the generated data signals to the pixels PX through a plurality of data lines DL.

In an embodiment, the data driving circuit 30 may be further connected to the pixels PX through a readout line (or reference voltage line, RVL). The data driving circuit 30 may sense the state of the pixels PX based on the electrical signals fed back from the pixels PX through the readout line RVL. In this embodiment, the timing controller 10 may select a pixel row and/or pixel PX to sense characteristic values for a predetermined period. The timing controller 10 may control the gate driving circuit 20 to apply gate signals of a specific level and/or pattern to the selected sensing pixels.

In response to the gate signals, when a sensing signal is output from the pixel PX, the data driving circuit 30 may generate sensing data Vsen based on the sensing signal. The timing controller 10 may generate compensated image data DATA by externally compensating the image data DATA based on the sensing data Vsen obtained through the data driving circuit 30. Compensation of the image data DATA may involve compensating for one or more of the threshold voltage, mobility, or the threshold voltage of the light-emitting device in the driving transistor provided in the pixel PX. By supplying the compensated image data DATA to the data driving circuit 30, image quality degradation, such as stains on the display panel 50, can be improved.

In various embodiments, the timing controller 10 may further apply control signals to the data driving circuit 30 to control the sensing mode. The sensing mode may be distinguished based on the sensing target and sensing method, for example. For example, the sensing mode may include a first mode for sensing the threshold voltage of the driving transistor in the pixel PX, a second mode for sensing the mobility of the driving transistor, a third mode for sensing the threshold voltage of the light-emitting device in the pixel PX, and a fourth mode for performing sensing of multiple pixels PX. Alternatively, the sensing mode may include a voltage-based sensing mode for sensing the voltage value of the sensing node in the pixel PX and a current-based sensing mode for sensing the current value.

The data driving circuit 30 may be implemented as a source drive circuit or a source drive integrated circuit (IC). The data driving circuit 30 may be connected to the bonding pads of the display panel 50 using tape automated bonding (TAB) or chip on glass (COG) methods, or directly arranged on the display panel 50, and in some cases, it may be integrated and arranged within the display panel 50.

For example, the data driving circuit 30 may include one or more source driver integrated circuits. Each source driver integrated circuit may include a shift register, a latch circuit, a digital-to-analog converter (DAC), and an output buffer. In some cases, an analog-to-digital converter (ADC) may further be included in each source driver integrated circuit.

The power supply unit 40 may generate a high-potential driving voltage ELVDD and a low-potential driving voltage ELVSS to be supplied to the display panel 50. The power supply unit 40 may provide the generated driving voltages ELVDD and ELVSS to the pixels PX through the corresponding power lines PL1 and PL2. The a power supply unit 40 may be referred to as a power management IC (PMIC).

The display panel 50 includes a plurality of pixels PX (or sub-pixels) arranged thereon. The pixels PX may be arranged in a matrix form on the display panel 50, for example. The pixels PX arranged in one pixel row are connected to the same gate line GL, and the pixels PX arranged in one pixel column are connected to the same data line DL. The pixels PX may emit light with brightness corresponding to the gate signals and data signals supplied through the gate lines GL and data lines DL.

In an embodiment, each pixel PX may display one of the colors, red, green, or blue. In another embodiment, each pixel PX may display one of the colors, cyan, magenta, or yellow. In various embodiments, each pixel PX may display one of the colors, red, green, blue, or white.

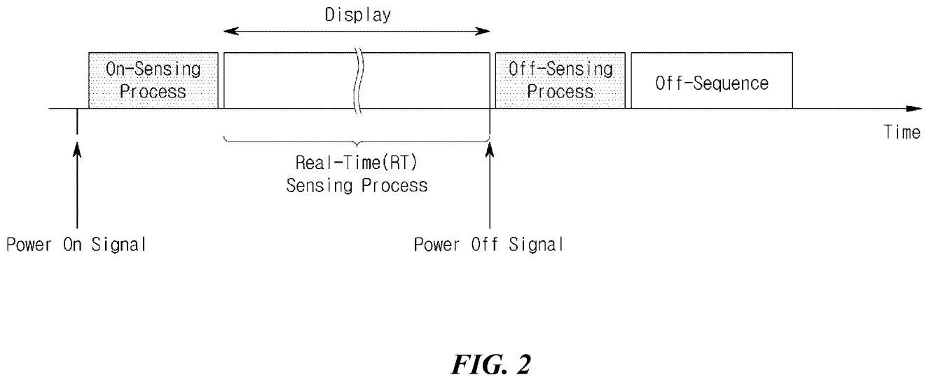

FIG. 2 is a diagram illustrating sensing timing according to an embodiment;

Referring to FIGS. 1 and 2, the display device 1 may sense the characteristic values of the drive transistors within each pixel PX disposed on the display panel 50 when the power-on signal is generated. This sensing process is referred to as the “on-sensing process.”

Additionally, the display device 1 may sense the characteristic values of the drive transistors and/or light-emitting elements within each pixel PX disposed on the display panel 50 after the power-off signal is generated and/or before the off-sequence, such as power cutoff, is carried out. This sensing process is referred to as the “off-sensing process.”

Additionally, the display device 1 may sense the characteristic values of the drive transistors and/or light-emitting elements within each pixel PX disposed on the display panel 50 during display operation, from the generation of the power-on signal until the generation of the power-off signal. This real-time sensing process is referred to as “real-time sensing process.” The real-time sensing process may be carried out during the blank time between active periods, based on the vertical sync signal.

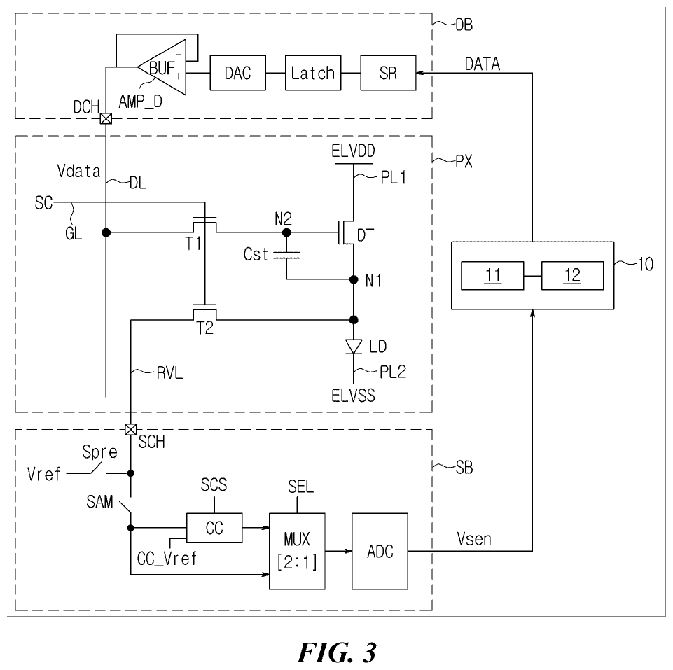

FIG. 3 is a diagram illustrating the connection relationship between the pixel, source drive circuit, and timing controller according to an embodiment.

Referring to FIG. 3, a pixel PX according to an embodiment may include a driving transistor DT, a light-emitting element LD connected to the driving transistor DT, and a control circuit for controlling the amount of driving current to be applied to the light-emitting element LD through the driving transistor DT. For example, the control circuit may include first and second transistors T1 and T2 and a storage capacitor Cst.

The first electrode of the driving transistor DT is configured to receive a high-level driving voltage ELVDD (connected to the high-level driving voltage line PL1), and the second electrode is connected to the light-emitting element LD through the first node N1. The gate electrode of the driving transistor DT is connected to the second node N2. The driving transistor DT may be turned on according to the voltage applied to the second node N2, thereby controlling the amount of driving current flowing to the light-emitting element LD.

The first electrode of the first transistor T1 is connected to the data line DL, and the second electrode is connected to the gate electrode of the driving transistor DT through the second node N2. The gate electrode of the first transistor T1 is connected to the gate line GL to receive a gate signal SC. The first transistor T1 can be turned on according to the gate signal SC applied to the gate line GL, allowing the data voltage Vdata applied to the data line DL to be transferred to the second node N2. This first transistor T1 may be referred to as a switching transistor.

The first electrode of the second transistor T2 is connected to the readout line RVL, and the second electrode is connected to the first node N1. The gate electrode of the second transistor T2 is connected to the gate line GL to receive the gate signal SC. The second transistor T2 may be turned on according to the gate signal SC applied to the gate line GL, and can sense a sensing signal (sensing voltage or sensing current) corresponding to the voltage or current of the first node N1, outputting the sensing signal to the readout line RVL. This second transistor T2 may be referred to as a sensing transistor.

The storage capacitor Cst is connected between the first node N1 and the second node N2. The storage capacitor Cst may store a voltage corresponding to the voltage difference between the first node N1 and the second node N2. For example, the storage capacitor Cst stores a voltage corresponding to the voltage difference between the data voltage Vdata applied to the data line DL and the voltage at the second node N2, maintaining the stored voltage for the duration of a frame period to stabilize the voltage at the gate electrode of the driving transistor DT (i.e., the second node N2).

The light-emitting device LD may be configured such that its anode electrode is connected to the first node N1 and its cathode electrode is connected to receive the low voltage drive voltage ELVSS (through the low voltage drive voltage line PL2). When the driving transistor DT is turned on, a current path is formed between the high voltage drive voltage ELVDD and the low voltage drive voltage ELVSS, allowing drive current to flow through the light-emitting device LD. The light-emitting device LD may emit light with brightness corresponding to the amount of the applied driving current.

In the embodiment of FIG. 3, the pixel PX may include an oxide semiconductor thin-film transistor. The oxide semiconductor thin-film transistor includes a gate electrode, a source electrode, and a drain electrode. The oxide semiconductor thin-film transistor has an active layer formed from an oxide semiconductor. Here, the oxide semiconductor may be an amorphous or crystalline oxide semiconductor. The oxide semiconductor thin-film transistor may be configured as an N-type transistor. The oxide semiconductor thin-film transistor allows for low-temperature processing and has a lower charge mobility compared to Low Temperature Poly-Silicon (LTPS) thin-film transistors. This type of oxide semiconductor thin-film transistor exhibits excellent off-current characteristics.

However, this embodiment is not limited to this configuration. In various other embodiments, the pixel PX may be entirely composed of LTPS thin-film transistors, or configured as a hybrid type with both oxide thin-film transistors and LTPS thin-film transistors.

The LTPS thin-film transistor includes a gate electrode, a source electrode, and a drain electrode. The LTPS thin-film transistor has an active layer made of polysilicon. Such an LTPS thin-film transistor may be configured as a P-type thin-film transistor. LTPS thin-film transistors have a high electron mobility, resulting in fast driving characteristics.

The timing controller 10 may include a compensation unit 11 that performs a compensation process to determine and compensate the characteristic values of the pixel PX based on the sensing data Vsen obtained through sensing the pixel PX, a memory 12 that stores the compensation values generated by the compensation unit 11. The compensation unit 11 and memory 12 may be provided within the timing controller 10, but the configuration is not limited thereto.

The compensation unit 11 may receive sensing data Vsen from the sensing block SB of the source driver integrated circuit, as described later. Based on the sensing data Vsen, the compensation unit 11 may determine the characteristic values (e.g., threshold voltage, mobility, etc.) of the circuit elements (e.g., driving transistor DT and/or light-emitting element LD) within the pixel PX and perform a compensation process for those characteristic values.

Specifically, the compensation unit 11 may calculate a compensation value (e.g., offset, gain, etc.) for characteristic value compensation and transmit the image data DATA, to which the computed compensation value is reflected, to the image driving block DB of the source driver integrated circuit. In the image driving block DB, the compensated image data DATA is converted into a data voltage Vdata, and the data voltage Vdata is supplied to the corresponding pixel PX, thereby completing the compensation process.

The data driving circuit 30 (see FIG. 1) may include one or more source driver integrated circuits. In FIG. 3, one source driver integrated circuit in the data driving circuit 30 is shown as an example. The source driver integrated circuit may include at least one image driving block DB and at least one sensing circuit block SB.

The sensing circuit block SB may include at least one sensing channel SCH. The sensing circuit block SB may be connected in a one-to-one relationship with the readout line RVL of the pixel PX through the sensing channel SCH.

The sensing circuit block SB may include an initialization switch Spre that controls the connection between the readout line RVL and the reference voltage Vref (for example, a sensing circuit reference voltage). When the initialization switch Spre is turned on, the reference voltage Vref may be supplied to the readout line RVL and applied to the first node N1 through the turned-on second transistor T2.

The sensing circuit block SB may include a sampling switch SAM that controls the connection between the readout line RVL, the control circuit CC, and the multiplexer MUX. The sampling switch SAM may operate as a sample-and-hold circuit that turns on when the first node N1 in the pixel PX reaches a voltage state reflecting the characteristic value of a desired circuit element, thereby applying the electrical signal supplied to the readout line RVL to the control circuit CC and the multiplexer MUX.

The sensing circuit unit SB may include a control circuit CC, a multiplexer MUX, and an analog-to-digital converter ADC.

The control circuit CC may be configured to receive a control circuit reference voltage CC_Vref and may be electrically connected to the readout line RVL. The control circuit CC may apply the control circuit reference voltage CC_Vref to the readout line RVL or receive an electrical signal output from the readout line RVL. The control circuit CC may process the electrical signal output from the readout line RVL and output the processed signal to the multiplexer MUX.

In an embodiment, the control circuit CC may be configured as an operational amplifier. One input terminal of the operational amplifier may receive the control circuit reference voltage CC_Vref, while the other input terminal may be electrically connected to the readout line RVL. The output terminal of the operational amplifier may be electrically connected to the multiplexer MUX. The operational amplifier may include at least one sampling capacitor connected to one of its input terminals and at least one feedback resistor.

The control circuit CC may include at least one switching element to perform the above operations. The switching element may turn on or off in response to a switching control signal SCS. Depending on the on/off state of the switching elements, the control circuit CC may control the electrical connection between the input terminal of the operational amplifier and the readout line RVL, between the control circuit reference voltage CC_Vref and the readout line RVL, and between the input and output terminals of the operational amplifier. Additionally, the control circuit CC may be configured to connect either the sampling capacitor or the feedback resistor to the input terminal of the operational amplifier based on the on/off states of the switching elements.

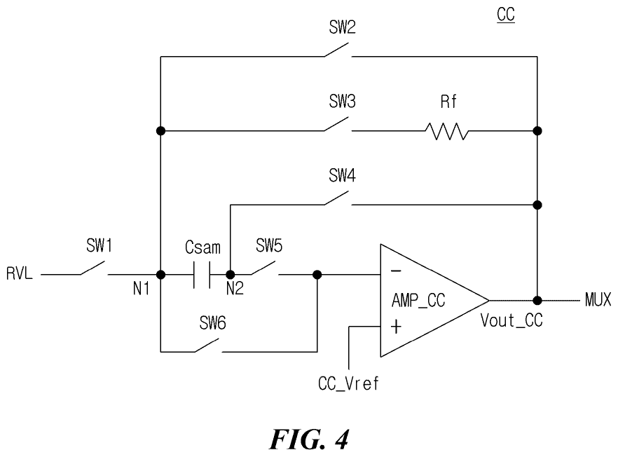

The detailed configuration of the control circuit CC will be described later with reference to FIG. 4.

The multiplexer MUX is connected to the output terminal of the control circuit CC and the readout line RVL. The multiplexer MUX is also connected to the analog-to-digital converter ADC. The multiplexer MUX may be a 2:1 multiplexer that electrically connects either the output terminal of the control circuit CC or the readout line RVL to the analog-to-digital converter ADC in response to a selection signal SEL applied from the timing controller 10 or the like.

For example, when the selection signal SEL at a first level (e.g., a low level) is applied, the multiplexer MUX may electrically connect the output terminal of the control circuit CC to the analog-to-digital converter ADC. Accordingly, the output signal from the control circuit CC may be input to the analog-to-digital converter ADC. Additionally, when a selection signal SEL at a second level (e.g., a high level) is applied, the multiplexer MUX may electrically connect the readout line RVL to the analog-to-digital converter ADC. Accordingly, the output signal from the readout line RVL may be input to the analog-to-digital converter ADC.

The control circuit CC and multiplexer MUX may be controlled differently depending on the pixel sensing mode. For example, in the first mode (voltage-based sensing mode), where the threshold voltage of the driving transistor DT is sensed based on the voltage value of the sensing node in the pixel PX (e.g., the first node N1), the control circuit CC may be controlled to electrically separate from the pixel PX, and the multiplexer MUX may be controlled to electrically connect the readout line RVL to the analog-to-digital converter ADC.

According to an embodiment, the control circuit CC may control switching elements to hold the sensing signal output from the pixel PX on a sampling capacitor for a predetermined period. In this embodiment, the control circuit CC may operate as a sample-and-hold circuit.

In the second mode (current-based sensing mode), where the mobility of the driving transistor DT is sensed based on the current value of the sensing node in the pixel PX, the control circuit CC may operate as a current-to-voltage converter with a feedback resistor connected between the input and output terminals, and the switching elements may be controlled to electrically connect the readout line RVL to the input terminal. The multiplexer MUX electrically separates the readout line RVL from the analog-to-digital converter ADC, and may be controlled to electrically connect the control circuit CC to the analog-to-digital converter ADC.

In the third mode (current-based sensing mode), where the threshold voltage of the light-emitting element is sensed based on the current value of the sensing node in the pixel PX, the control circuit CC may operate as a current integrator with a sampling capacitor connected between the input and output terminals, and the switching elements may be controlled to electrically connect the readout line RVL to the input terminal. The multiplexer MUX electrically separates the readout line RVL from the analog-to-digital converter ADC, and may be controlled to electrically connect the control circuit CC to the analog-to-digital converter ADC.

The detailed operations of the sensing modes of the control circuit CC and multiplexer MUX will be described later.

The analog-to-digital converter ADC may convert the sensing voltage output from the multiplexer MUX into sensing data Vsen in digital format. The ADC may then transmit the converted sensing data Vsen to the timing controller 10.

In an embodiment, the sensing circuit SB may further include a scaler. The scaler may adjust the signal output from the multiplexer MUX to fit within the operating range of the analog-to-digital converter ADC.

The sensing circuit SB may be provided within the source driver integrated circuit as shown. However, this embodiment is not limited thereto. In other embodiments, the sensing circuit SB may be provided as a separate component from the source driver integrated circuit.

The image driving block DB may include at least one driving channel DCH. The image driving block DB may be connected one-to-one to the data line DL of the pixel PX through the driving channel DCH.

The image driving block DB may include a shift register unit SR, a latch unit Latch, a digital-to-analog converter DAC, and an output buffer BUF.

The shift register unit SR may sequentially output latch pulses to the multiple latches included in the latch unit Latch.

The latch unit Latch may latch the compensated image data DATA applied from the timing controller 10 and output in response to the latch pulse.

The digital-to-analog converter DAC may convert the compensated image data DATA output from the latch unit Latch into analog data voltage Vdata and output converted data.

The output buffer BUF may buffer the data voltage Vdata output from the digital-to-analog converter DAC and then output the buffered voltage to the data line DL through the driving channel DCH. The output buffer BUF may be a buffer circuit including an operational amplifier AMP_D. For example, the output buffer BUF may be an operational amplifier circuit with a unit gain function, having a gain of 1.

The operational amplifier AMP_D may include a non-inverting input terminal (+), an inverting input terminal (−), and an output terminal. The non-inverting input terminal (+) of the operational amplifier AMP_D may be electrically connected to the digital-to-analog converter DAC. The inverting input terminal (−) of the operational amplifier AMP_D may be electrically connected to the output terminal. The output terminal of the operational amplifier AMP_D may be electrically connected to the driving channel DCH.

FIG. 4 is a circuit diagram illustrating the configuration of the control circuit according to an embodiment.

Referring to FIG. 4, the control circuit CC according to an embodiment may include an operational amplifier AMP_CC, a sampling capacitor Csam, a feedback resistor Rf, and at least one switching element SW1 to SW6.

The operational amplifier AMP_CC is connected between the readout line RVL and the multiplexer MUX. The non-inverting input terminal (+) of the operational amplifier AMP_CC is supplied with the control circuit reference voltage CC_Vref. The inverting input terminal (−) of the operational amplifier AMP_CC is connected to the switching elements SW1 to SW6 via the first node N1 and may be electrically connected to the read-out line RVL through some of the switching elements SW1 to SW6. The output terminal Vout_CC of the operational amplifier AMP_CC may be electrically connected to the multiplexer MUX (FIG. 3).

The first switching element SW1 may be connected between the read-out line RVL (FIG. 3) and the first node N1. The first switching element SW1 may be turned on in response to a switching control signal at a turn-on level (e.g., a high level), electrically connecting the read-out line RVL and the first node N1.

The second switching element SW2 is connected between the first node N1 and the output terminal Vout_CC of the operational amplifier AMP_CC. The second switching element SW2 may be turned on in response to a switching control signal at a turn-on level (e.g., a high level), electrically connecting the inverting input terminal (−) and the output terminal Vout_CC of the operational amplifier AMP_CC.

The third switching element SW3 and the feedback resistor Rf are connected in series between the first node N1 and the output terminal Vout_CC of the operational amplifier AMP_CC. The third switching element SW3 may be turned on in response to a switching control signal at a turn-on level (e.g., a high level), electrically connecting the first node N1 and the output terminal Vout_CC. When the third switching element SW3 is turned on, an electrical path including the feedback resistor Rf may be formed between the first node N1 and the output terminal Vout_CC.

The fourth switching element SW4 is connected between the second node N2 and the output terminal Vout_CC of the operational amplifier AMP_CC. The fourth switching element SW4 may be turned on in response to a switching control signal at a turn-on level (e.g., a high level), electrically connecting the inverting input terminal (−) and the output terminal Vout_CC of the operational amplifier AMP_CC.

The fifth switching element SW5 and the sampling capacitor Csam are connected between the first node N1 and the inverting input terminal (−). For example, the sampling capacitor Csam is connected between the first node N1 and the second node N2, and the fifth switching element SW5 is connected between the second node N2 and the inverting input terminal (−). The fifth switching element SW5 may be turned on in response to a switching control signal at a turn-on level (e.g., a high level), electrically connecting the first node N1 and the inverting input terminal (−). When the fifth switching element SW5 is turned on, an electrical path including the sampling capacitor Csam may be formed between the first node N1 and the inverting input terminal (−). Additionally, when the fifth switching element SW5 is turned on, the sampling capacitor Csam may be connected to the inverting input terminal (−) of the operational amplifier AMP_CC.

The sixth switching element SW6 is connected between the first node N1 and the inverting input terminal (−). The sixth switching element SW6 may be turned on in response to a switching control signal at a turn-on level (e.g., a high level), electrically connecting the first node N1 and the inverting input terminal (−).

Hereinafter, the detailed operation of the control circuit CC will be described.

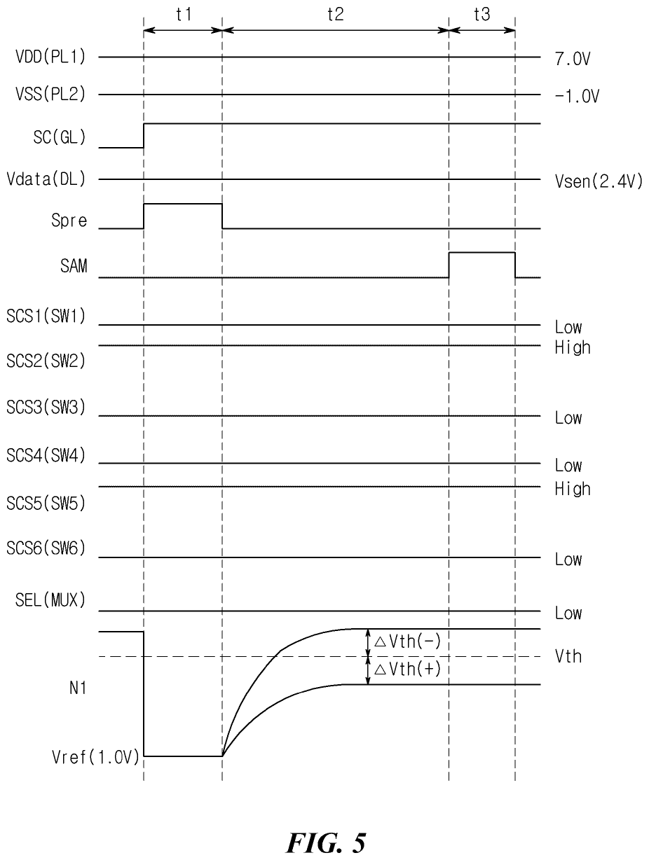

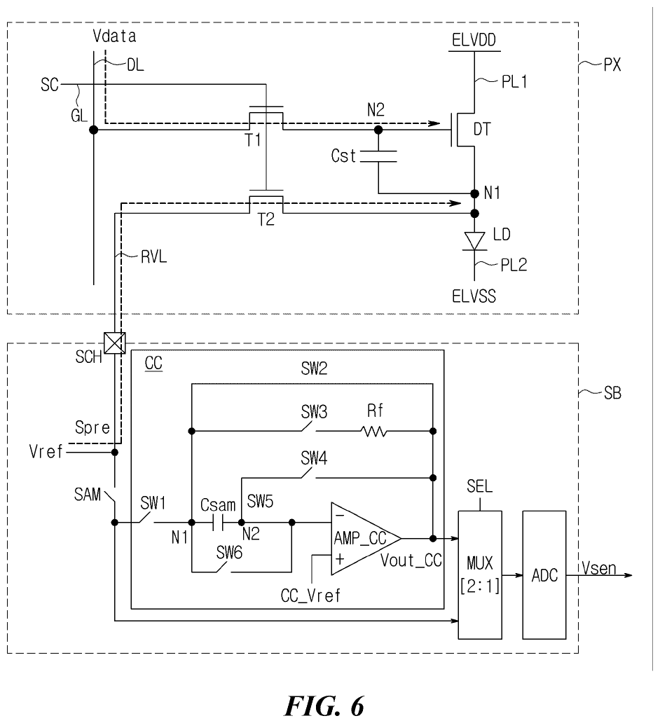

FIG. 5 is a timing diagram illustrating the voltage-based pixel sensing method according to the first embodiment. FIGS. 6 to 8 are diagrams for explaining the pixel sensing method according to the embodiment of FIG. 5.

During pixel sensing, a high-potential driving voltage ELVDD and a low-potential driving voltage ELVSS may be applied to the pixel PX. The high-potential driving voltage ELVDD may be, for example, approximately 7V, and the low-potential driving voltage ELVSS may be, for example, approximately −1V. However, these values are not limited thereto.

Referring to FIGS. 5 and 6, during the initialization period t1, a turn-on signal is applied to the initialization switch Spre, and a gate signal SC at a turn-on level is applied to the gate line GL. Additionally, during the initialization period t1, a predetermined sensing data voltage Vsens may be applied to the data line DL. For example, the sensing data voltage Vsens may be a voltage sufficient to turn on the driving transistor DT, such as approximately 2.4V, but is not limited thereto.

In response to the switching signal and the gate signal SC, when the initialization switch Spre and the second transistor T2 are turned on, the initialization voltage Vref is applied to the first node N1, and the voltage of the first node N1 can be initialized. The initialization voltage Vref may be approximately 1V, for example, but is not limited thereto. Additionally, in response to the gate signal SC, when the first transistor T1 is turned on, the sensing data voltage Vsens is applied to the second node N2, turning on the driving transistor DT.

During the initialization period t1, a voltage corresponding to the difference between the sensing data voltage Vsens and the initialization voltage Vref may be stored in the storage capacitor Cst.

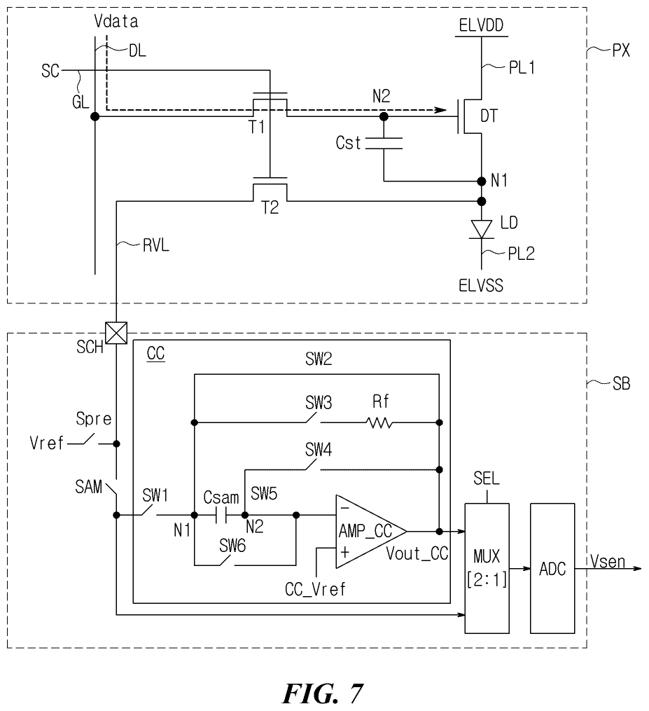

Referring to FIGS. 5 and 7, during the tracking period t2, a turn-off signal is applied to the initialization switch Spre, and the initialization switch Spre may be turned off.

Since the sensing data voltage Vsens continues to be applied during the tracking period t2, the driving transistor DT can maintain the turned-on state. When the initialization switch Spre is turned off, the turned-on driving transistor DT operates in a source follower state, and the voltage of the first node N1 gradually increases. The voltage of the first node N1 may saturate upon reaching the difference voltage (Vsens−Vth) between the sensing data voltage Vsens and the threshold voltage Vth, or upon reaching the difference voltage (Vsens−ΔVth) between the sensing data voltage Vsens and the threshold voltage deviation ΔVth.

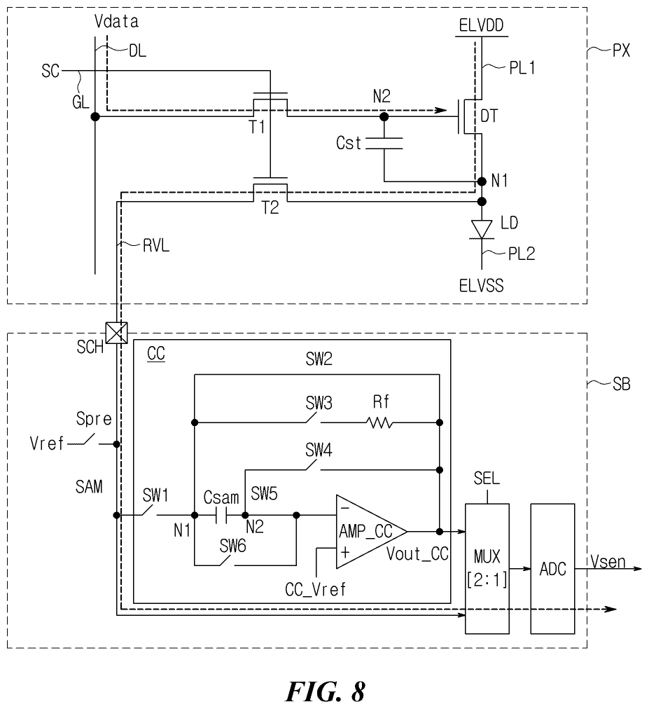

Once the voltage of the first node N1 saturates, the sampling period t3 may begin. Referring to FIGS. 5 and 8, during the sampling period t3, a turn-on signal is applied to the sampling switch SAM, and the sampling switch SAM may be turned on. As a result, the read-out line RVL and the sensing circuit SB may be electrically connected.

During the sampling period t3, a first-level, i.e., low-level selection signal SEL, may be applied to the multiplexer MUX. Accordingly, the control circuit CC is electrically separated from the read-out line RVL, and the multiplexer MUX, in response to the low-level selection signal SEL, may electrically connect the read-out line RVL and the analog-to-digital converter ADC.

During the sampling period t3, the analog-to-digital converter ADC, connected to the read-out line RVL, may sense the voltage of the read-out line RVL. Here, the voltage of the read-out line RVL may correspond to the voltage of the first node N1. As a result, the analog-to-digital converter ADC may convert the sensing voltage, corresponding to the difference voltage (Vsens−Vth) between the sensing data voltage Vsens and the threshold voltage Vth, or the difference voltage (Vsens−ΔVth) between the sensing data voltage Vsens and the threshold voltage deviation ΔVth, into digital sensing data Vsen.

As described above, in the first mode (voltage-based sensing mode), which senses the threshold voltage of the driving transistor DT based on the voltage value of the sensing node (e.g., the first node N1) within the pixel PX, the control circuit CC may be controlled to be electrically separated from the pixel PX, and the multiplexer MUX may be controlled to electrically connect the readout line RVL and the analog-to-digital converter ADC.

In the voltage-based pixel sensing method according to the first embodiment, a first switching control signal SCS1 at the turn-off level may be applied to the first switching element SW1 of the control circuit CC, thereby turning off the first switching element SW1. That is, the control circuit CC is electrically separated from the pixel PX. Accordingly, the second to sixth switching elements SW2 to SW6 in the control circuit CC may all be controlled to remain in the turn-off state.

However, in another embodiment, at least one of the second to sixth switching elements SW2 to SW6 may be controlled to remain in the turn-on state to stabilize the operational amplifier AMP_CC. For example, in the voltage-based pixel sensing method according to the first embodiment, the second switching element SW2 and the fifth switching element SW5 may be controlled to remain in the turn-on state through the second and fifth switching control signals SCS2 and SCS5. Accordingly, the inverting input terminal (−) and the output terminal Vout_CC of the operational amplifier AMP_CC may be electrically connected, and the sampling capacitor Csam may be connected to the inverting input terminal (−). In this embodiment, the operational amplifier AMP_CC may function as a buffer circuit that stores the control circuit reference voltage CC_Vref.

In the voltage-based pixel sensing method according to the first embodiment, an analog-to-digital converter ADC may be provided for each sensing circuit unit SB. That is, the ADC may be configured to generate sensing data Vsen based on the sensing voltage output from the corresponding readout line RVL during the sensing process.

In another embodiment, a single ADC may be provided for multiple sensing circuit units SB. That is, in an embodiment, a plurality of sensing circuit units SB may be configured to share a single ADC. In this embodiment, each of the plurality of sensing circuit units SB may hold the sensing voltage during the tracking period t2, and during the sampling period t3, the ADC may be configured to receive the sensing voltage sequentially output from the multiple sensing circuit units SB.

Hereinafter, this embodiment will be described in more detail.

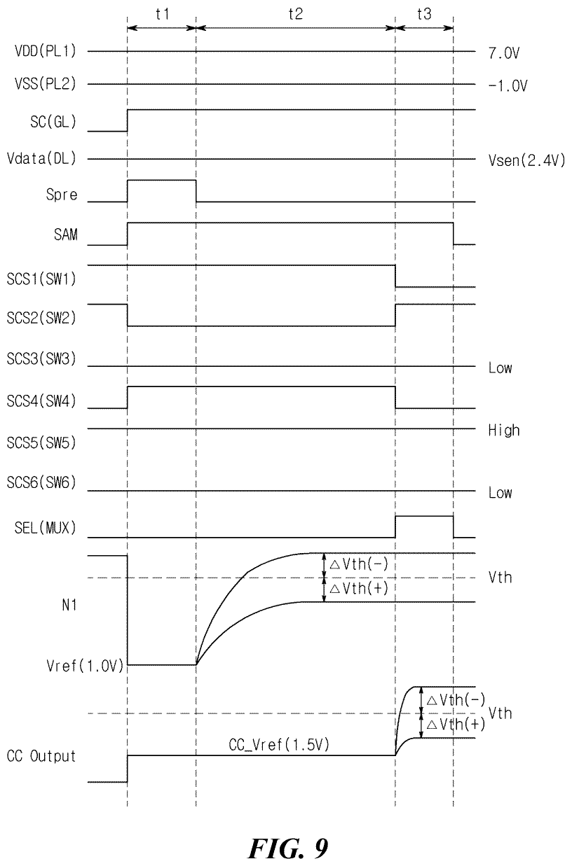

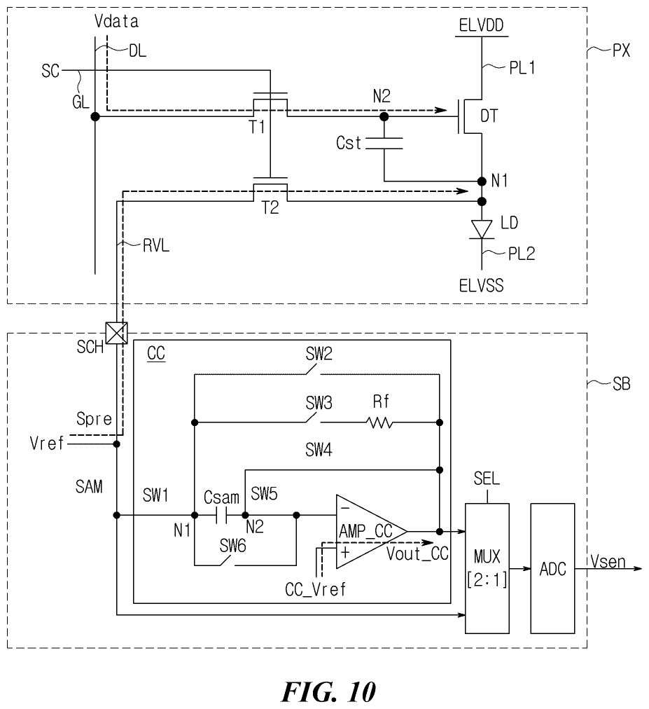

FIG. 9 is a timing diagram illustrating the voltage-based pixel sensing method according to the second embodiment. FIGS. 10 to 12 are diagrams for explaining the pixel sensing method according to the embodiment of FIG. 9.

During pixel sensing, a high-potential driving voltage ELVDD and a low-potential driving voltage ELVSS may be applied to the pixel PX. The high-potential driving voltage ELVDD may be, for example, approximately 7V, and the low-potential driving voltage ELVSS may be, for example, approximately −1V. However, these values are not limited thereto.

Referring to FIGS. 9 and 10, during the initialization period t1, a turn-on signal is applied to the initialization switch Spre, a gate signal SC of a turn-on level is applied to the gate line GL, and a predetermined sensing data voltage Vsens may be applied to the data line DL. For example, the sensing data voltage may be a voltage capable of turning on the driving transistor DT and may be approximately 2.4V, but is not limited thereto. Additionally, during the initialization period t1, a switching control signal at a turn-on level (SCS1, SCS4, and SCS5) may be applied to the sampling switch SAM, the first switching element SW1, the fourth switching element SW4, and the fifth switching element SW5 of the control circuit CC.

In response to the switching signal and the gate signal SC, when the initialization switch Spre and the second transistor T2 are turned on, the initialization voltage Vref is applied to the first node N1, and the voltage of the first node N1 can be initialized. The initialization voltage Vref may be approximately 1V, for example, but is not limited thereto. Additionally, in response to the gate signal SC, when the first transistor T1 is turned on, the sensing data voltage Vsens is applied to the second node N2, turning on the driving transistor DT.

During the initialization period t1, a voltage corresponding to the difference between the sensing data voltage Vsens and the initialization voltage Vref may be stored in the storage capacitor Cst.

Meanwhile, during the initialization period t1, the operational amplifier AMP_CC may output the control circuit reference voltage CC_Vref, which is input to its non-inverting input terminal+. The control circuit reference voltage CC_Vref may be, for example, approximately 1.5V, but is not limited thereto.

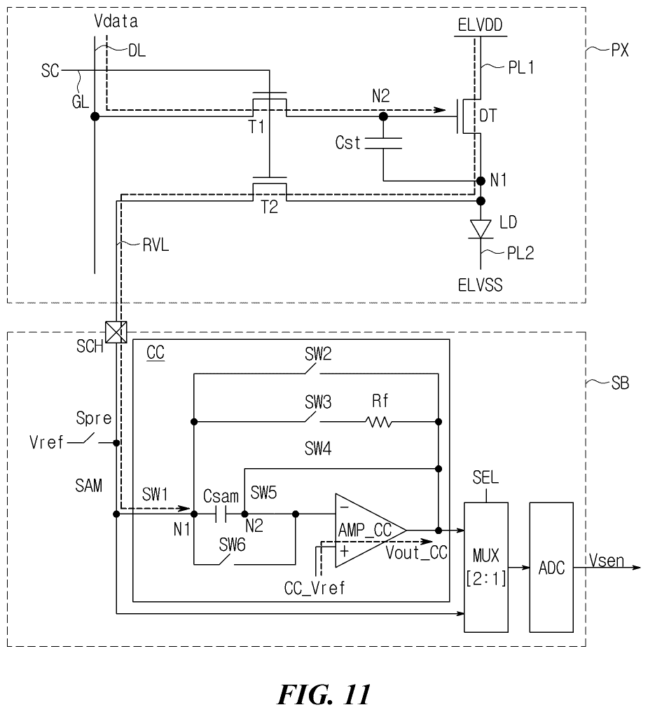

Referring to FIGS. 9 and 11, during the tracking period t2, a turn-off signal is applied to the initialization switch Spre, and the initialization switch Spre may be turned off.

Since the sensing data voltage Vsens continues to be applied during the tracking period t2, the driving transistor DT can maintain the turned-on state. When the initialization switch Spre is turned off, the turned-on driving transistor DT operates in a source follower state, and the voltage of the first node N1 gradually increases. The voltage of the first node N1 may saturate upon reaching the difference voltage (Vsens−Vth) between the sensing data voltage Vsens and the threshold voltage Vth, or upon reaching the difference voltage (Vsens−ΔVth) between the sensing data voltage Vsens and the threshold voltage deviation ΔVth.

During the tracking period t2, the first node N1 may be electrically connected to the sampling capacitor Csam through the second transistor T2, the readout line RVL, the sampling switch SAM, and the first switching element SW1. The sampling capacitor Csam may store (sample) a voltage corresponding to the difference between the sensing voltage of the first node N1 and the control circuit reference voltage CC_Vref.

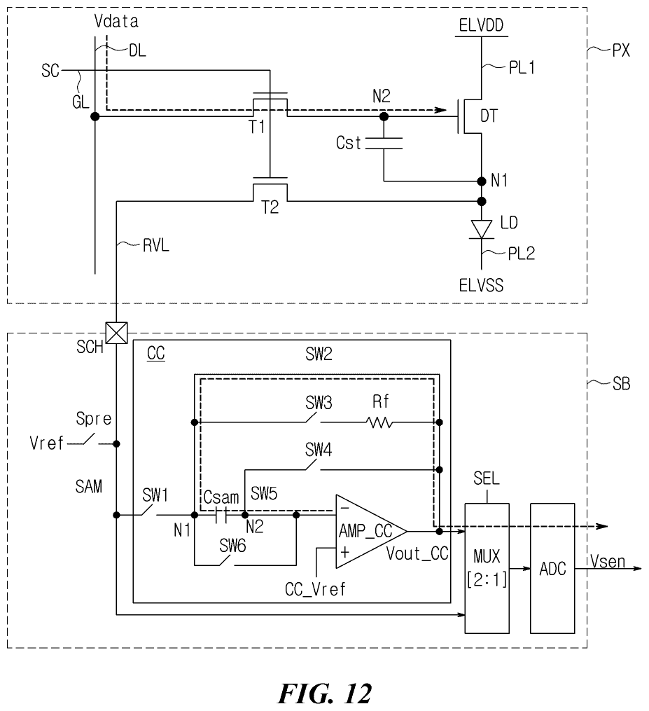

After the voltage of the first node N1 becomes saturated, the sampling period t3 may begin. Referring to FIG. 9 and FIG. 12, during the sampling period t3, a turn-off signal is applied to the first switching element SW1, turning the first switching element SW1 off. Also, during the sampling period t3, a turn-on signal is applied to the second switching element SW2, and a turn-off signal is applied to the fourth switching element SW4, so that the second switching element SW2 is turned on and the fourth switching element SW4 is turned off.

When the first switching element SW1 is turned off, the voltage previously stored in the sampling capacitor Csam, i.e., the difference voltage between the sensing voltage and the control circuit reference voltage CC_Vref, may be applied to the inverting input terminal (−) of the operational amplifier AMP_CC. The operational amplifier AMP_CC can perform the function of a unit gain buffer with a gain of 1, as its inverting input terminal (−) and output terminal Vout_CC are connected via the second switching element SW2. The operational amplifier AMP_CC can output the difference voltage between the input from the sampling capacitor Csam and the control circuit reference voltage CC_Vref at its output terminal Vout_CC. In this case, the output voltage corresponds to the sensing voltage of the first node N1.

During the sampling period t3, the analog-to-digital converter ADC may sense the output voltage from the control circuit CC. Here, the output voltage from the operational amplifier (AMP_CC) corresponds to the sensing voltage of the first node (N1), which is stored in the sampling capacitor (Csam) during the tracking period (t2), and may be the difference voltage (Vsens−Vth) between the sensing data voltage (Vsens) and the threshold voltage (Vth), or the difference voltage (Vsens−ΔVth) between the sensing data voltage (Vsens) and the threshold voltage deviation (ΔVth). As a result, the analog-to-digital converter ADC may convert the sensing voltage, corresponding to the difference voltage (Vsens−Vth) between the sensing data voltage Vsens and the threshold voltage Vth, or the difference voltage (Vsens−ΔVth) between the sensing data voltage Vsens and the threshold voltage deviation ΔVth, into digital sensing data Vsen.

In this embodiment, the control circuit CC may operate in a voltage-based sensing mode (e.g., the 4th mode), storing the sensing voltage of the first node N1 during the tracking period t2, and acting as a sample-and-hold circuit that outputs the stored sensing voltage to the analog-to-digital converter ADC during the sampling period t3.

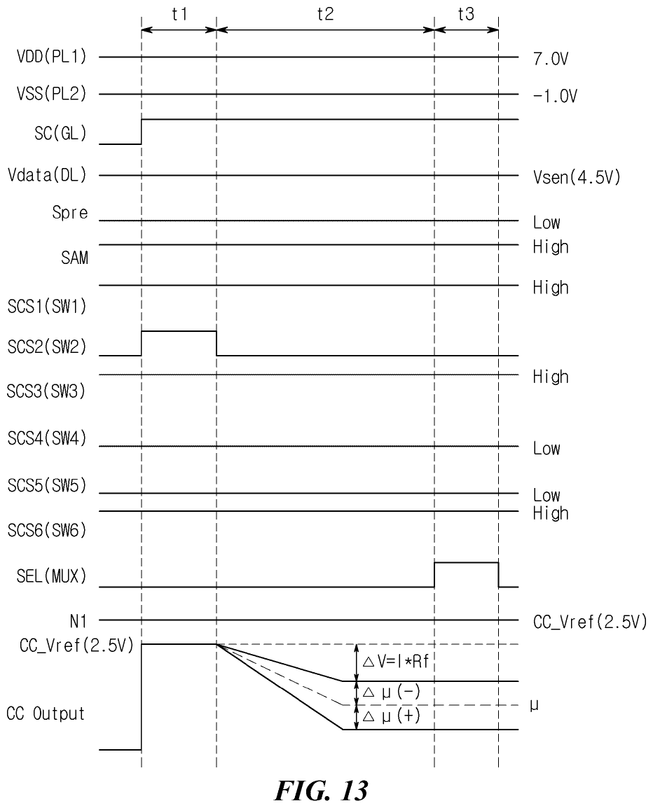

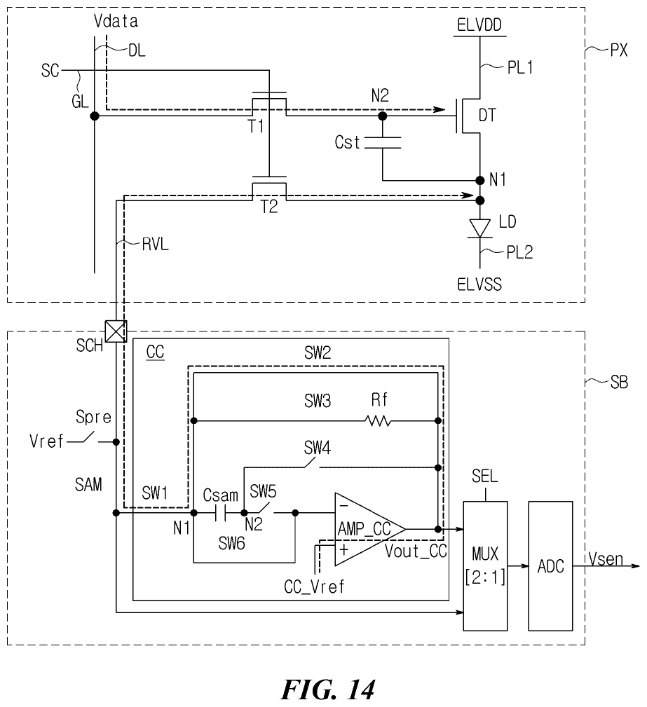

FIG. 13 is a timing diagram illustrating the current-based pixel sensing method according to the third embodiment. FIGS. 14 to 16 are diagrams for explaining the pixel sensing method according to the embodiment of FIG. 13.

During pixel sensing, a high-potential driving voltage ELVDD and a low-potential driving voltage ELVSS may be applied to the pixel PX. The high-potential driving voltage ELVDD may be, for example, approximately 7V, and the low-potential driving voltage ELVSS may be, for example, approximately −1V. However, these values are not limited thereto.

Referring to FIGS. 13 and 14, during the initialization period t1, a turn-on level gate signal SC is applied to the gate line GL, and a predetermined sensing data voltage Vsens may be applied to the data line DL. For example, the sensing data voltage Vsens may be a voltage sufficient to turn on the driving transistor DT, such as approximately 4.5V, but is not limited thereto. Additionally, during the initialization period t1, turn-on signals may be applied to the sampling switch SAM, the first switching element SW1, the second switching element SW2, the third switching element SW3, and the sixth switching element SW6 of the control circuit CC.

In response to the gate signal SC, when the first transistor T1 is turned on, the sensing data voltage Vsens may be applied to the second node N2.

Furthermore, in response to the gate signal SC, when the second transistor T2 is turned on, and when the sampling switch SAM, the first switching element SW1, and the sixth switching element SW6 are turned on, the inverting input terminal of the operational amplifier AMP_CC may be connected to the first node N1. Moreover, when the second switching element SW2 and the third switching element SW3 are turned on, the inverting input terminal and the output terminal Vout_CC of the operational amplifier AMP_CC may be electrically connected.

During the initialization period t1, the operational amplifier AMP_CC may output the control circuit reference voltage CC_Vref, which is input to its non-inverting input terminal+. The control circuit reference voltage CC_Vref outputted to the output terminal Vout_CC may be applied to the first node N1 through the second switching element SW2 and the first switching element SW1. As a result, the voltage of the first node N1 may be initialized to the control circuit reference voltage CC_Vref. The control circuit reference voltage CC_Vref may be, for example, approximately 2.5V, but is not limited thereto.

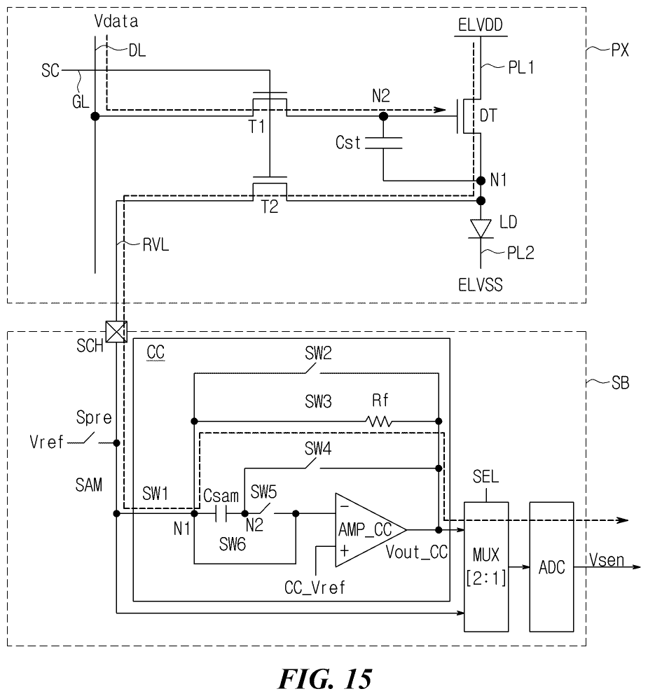

Referring to FIG. 13 and FIG. 15, during the tracking period t2, a turn-off signal may be applied to the second switching element SW2, turning the second switching element SW2 off. As a result, the operational amplifier AMP_CC can function as a current-to-voltage conversion circuit and/or a current integrator with a feedback resistor Rf connected between the inverting input terminal (−) and the output terminal Vout_CC.

During the tracking period t2, a current path is formed from the high-potential driving voltage ELVDD to the first node N1 via the turned-on driving transistor DT. The current flowing to the first node N1 may gradually increase until the voltage at the first node N1 reaches the difference voltage (Vsens−Vth) between the sensing data voltage Vsens and the threshold voltage Vth. Here, the saturated current is determined based on the mobility (μ) or mobility deviation (Δμ) of the driving transistor DT.

The sensing current applied to the first node N1 may be applied to the control circuit CC via the read-out line RVL. The operational amplifier AMP_CC may convert the sensing current input through the read-out line RVL into a voltage and output the converted voltage. As the sensing current increases, the voltage difference between the inverting input terminal (−) and the non-inverting input terminal (+) of the operational amplifier AMP_CC, which is applied with the control circuit reference voltage CC_Vref, gradually decreases. Therefore, the output voltage of the operational amplifier AMP_CC may gradually decrease in correspondence to the magnitude of the sensing current until the sensing current saturates.

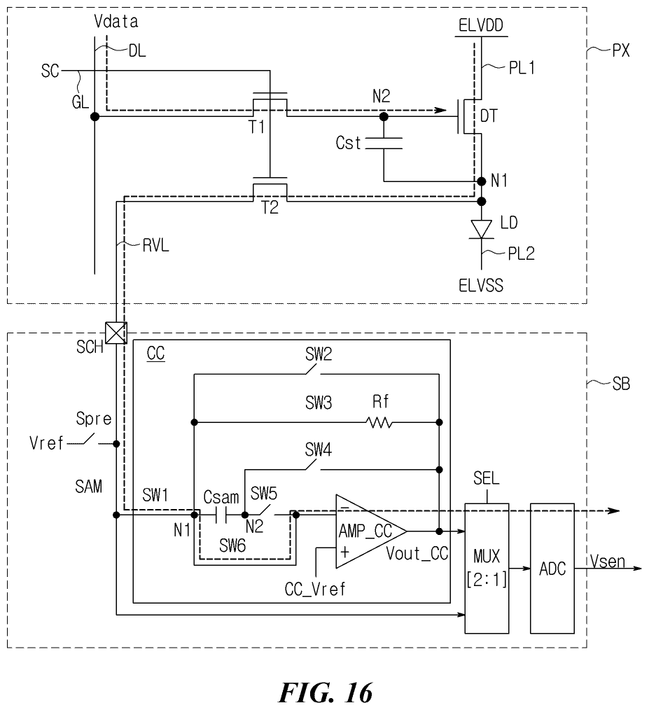

Once the output voltage reaches saturation, the sampling period t3 may begin. Referring to FIG. 13 and FIG. 16, during the sampling period t3, a high-level selection signal SEL may be applied to the multiplexer MUX. As a result, the output terminal Vout_CC of the operational amplifier AMP_CC in the control circuit CC may be electrically connected to the analog-to-digital converter ADC.

During the sampling period t3, the analog-to-digital converter ADC may sense the output voltage from the control circuit CC. The output voltage here may be a value reflecting the mobility μ of the driving transistor DT or the mobility deviation Δμ. As a result, the analog-to-digital converter ADC may convert the sensing current, which reflects the mobility μ or mobility deviation Δμ of the driving transistor DT, into digital sensing data Vsen.

Thus, in the second mode (current-based sensing mode), which senses the mobility of the driving transistor DT based on the current value of the sensing node within the pixel PX, the control circuit CC operates as a current-to-voltage converter with feedback resistance Rf connected between the input and output terminals, and switching elements may be controlled to electrically connect the read-out line RVL and the input terminal. The multiplexer MUX electrically separates the readout line RVL from the analog-to-digital converter ADC, and may be controlled to electrically connect the control circuit CC to the analog-to-digital converter ADC.

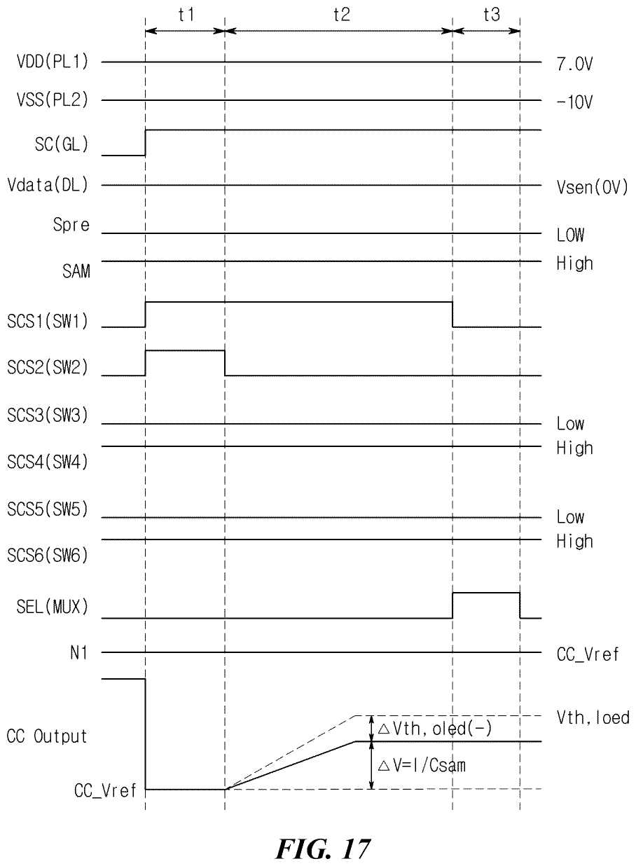

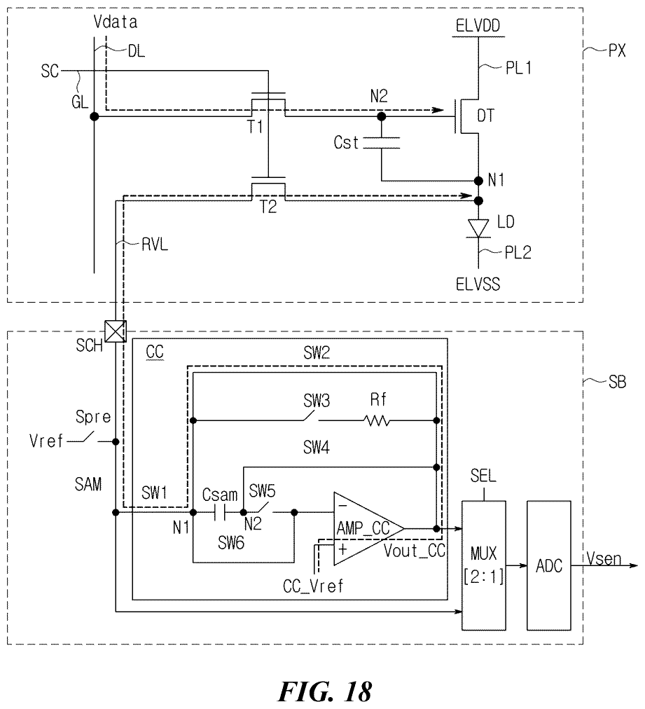

FIG. 17 is a timing diagram illustrating the current-based pixel sensing method according to the fourth embodiment; and FIGS. 18 to 20 are diagrams for explaining the pixel sensing method according to the embodiment of FIG. 17.

During pixel sensing, a high-potential driving voltage ELVDD and a low-potential driving voltage ELVSS may be applied to the pixel PX. The high-potential driving voltage ELVDD may be, for example, approximately 7V, and the low-potential driving voltage ELVSS may be, for example, approximately −10V. However, these values are not limited thereto.

Referring to FIGS. 17 and 18, during the initialization period t1, a turn-on level gate signal SC is applied to the gate line GL, and a predetermined sensing data voltage Vsens may be applied to the data line DL.

Additionally, during the initialization period t1, turn-on signals may be applied to the sampling switch SAM, the first switching element SW1, the second switching element SW2, the fourth switching element SW4, and the sixth switching element SW6 of the control circuit CC.

In response to the gate signal SC, when the first transistor T1 is turned on, the sensing data voltage Vsens may be applied to the second node N2. For example, the sensing data voltage Vsens may be a voltage sufficient to turn off the driving transistor DT and corresponding to a data voltage for the black gradation, and in an embodiment, may be approximately 0V, without being limited thereto.

Furthermore, in response to the gate signal SC, when the second transistor T2 is turned on, and when the sampling switch SAM, the first switching element SW1, and the sixth switching element SW6 are turned on, the inverting input terminal of the operational amplifier AMP_CC may be connected to the first node N1. Additionally, when the second switching element SW2 is turned on, the inverting input terminal (−) and the output terminal Vout_CC of the operational amplifier AMP_CC may be electrically connected.

During the initialization period t1, the operational amplifier AMP_CC may output the control circuit reference voltage CC_Vref, which is input to its non-inverting input terminal+. The control circuit reference voltage CC_Vref outputted to the output terminal Vout_CC may be applied to the first node N1 through the second switching element SW2 and the first switching element SW1. As a result, the voltage of the first node N1 may be initialized to the control circuit reference voltage CC_Vref. The control circuit reference voltage CC_Vref may be a voltage sufficient to turn on the light-emitting device LD and may be higher than the threshold voltage Vth, oled of the light-emitting device LD. Consequently, the light-emitting device LD is turned on, and current may flow from the first node N1 through the light-emitting device LD and the low-potential driving voltage ELVSS.

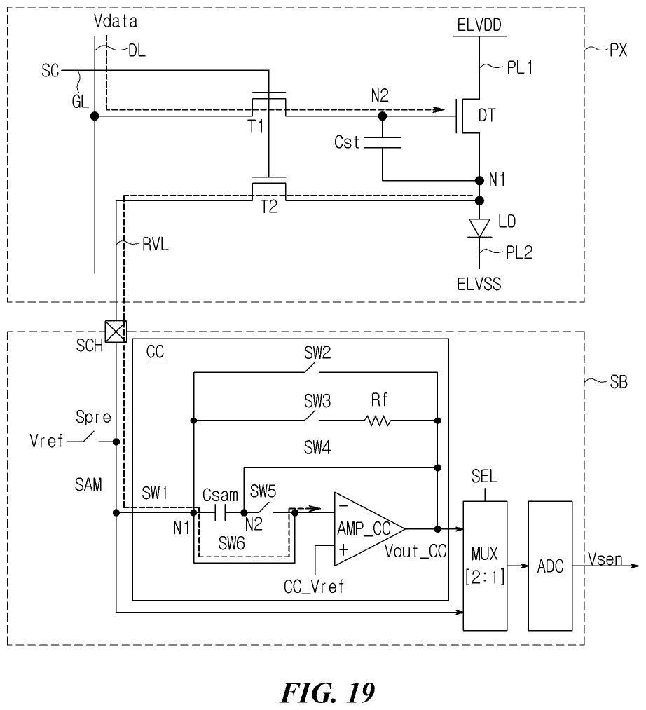

Referring to FIG. 17 and FIG. 19, during the tracking period t2, a turn-off signal may be applied to the second switching element SW2, turning the second switching element SW2 off. Then, the operational amplifier AMP_CC may function as a current integrator with a sampling capacitor Csam connected between the inverting input terminal (−) and the output terminal Vout_CC.

During the tracking period t2, current may flow from the turned-on light-emitting element LD to the control circuit CC. The voltage at the first node N1 may gradually decrease due to current leakage. When the voltage at the first node N1 reaches the threshold voltage Vth, oled of the light-emitting element LD, the light-emitting element LD will turn off, and no more current will flow, causing the voltage at the first node N1 to saturate.

The operational amplifier AMP_CC in the control circuit CC may integrate the current output while the light-emitting element LD is turned on, convert the integrated current into a voltage, and output the converted voltage. The output voltage of the operational amplifier AMP_CC may gradually increase until the voltage at the first node N1 saturates. Here, the change in the output voltage of the operational amplifier AMP_CC may correspond to dividing the current (I) applied to the first node N1 by the capacitance value of the sampling capacitor Csam. When the voltage at the first node N1 saturates, the output voltage of the operational amplifier AMP_CC may correspond to the threshold voltage Vth, oled of the light-emitting element LD.

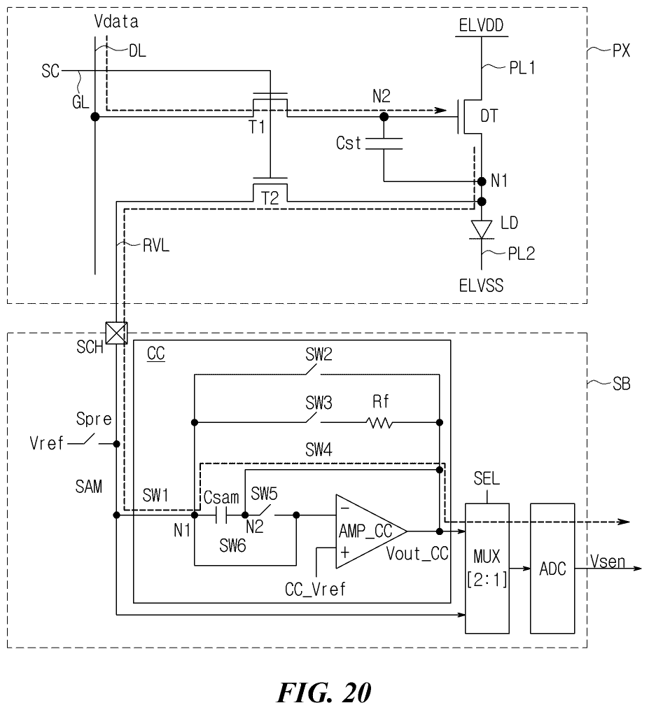

Once the voltage of the first node N1 saturates, the sampling period t3 may begin. Referring to FIG. 17 and FIG. 20, during the sampling period t3, a turn-off signal is applied to the first switching element SW1, turning the first switching element SW1 off. Additionally, during the sampling period t3, a second level, i.e., a high-level selection signal SEL, may be applied to the multiplexer MUX. As a result, the output terminal Vout_CC of the operational amplifier AMP_CC in the control circuit CC may be electrically connected to the analog-to-digital converter ADC.

During the sampling period t3, the analog-to-digital converter ADC may sense the output voltage from the control circuit CC. Here, the output voltage may correspond to the threshold voltage Vth, oled of the light-emitting element LD. As a result, the analog-to-digital converter ADC may convert the sensing voltage, reflecting the threshold voltage Vth, oled of the light-emitting element LD, into digital sensing data Vsen.

As described above, in the third mode (current-based sensing mode) for sensing the threshold voltage of the light-emitting element based on the current value of the sensing node in the pixel PX, the control circuit CC may operate as a current integrator in which a sampling capacitor Cf is connected between the input and output terminals, and switching elements may be controlled such that the read-out line RVL and the input terminal are electrically connected. The multiplexer MUX electrically separates the readout line RVL from the analog-to-digital converter ADC, and may be controlled to electrically connect the control circuit CC to the analog-to-digital converter ADC.

The data driving circuit, driving method of the data driving circuit, and display device including the data driving circuit according to the embodiments are advantageous for improving image quality by sensing the pixel characteristic values and compensating the image data based on those characteristic values.

The data driving circuit, driving method of the data driving circuit, and display device including the data driving circuit according to the embodiments are advantageous for performing voltage-based or current-based sensing through a control circuit capable of implementing various sensing modes.

The data driving circuit, driving method of the data driving circuit, and display device including the data driving circuit according to the embodiments are advantageous for minimizing the number and size of circuit elements required for the sensing circuit while enabling the generation of various sensing data based on voltage and current.

Although embodiments of this disclosure have been described above with reference to the accompanying drawings, it will be understood that the technical configuration of this disclosure described above can be implemented in other specific forms by those skilled in the art without changing the technical concept or essential features of the present disclosure. Therefore, it should be understood that the embodiments described above are exemplary and not limited in all respects. In addition, it should be understood that all modifications or variations derived from the meaning and scope of the embodiments and their equivalent concept are included within the scope of the this disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A data driving circuit comprising:
a control circuit electrically connected to a sensing node in a pixel through a readout line;
a multiplexer comprising an input terminal connected to the readout line and the control circuit, and configured to electrically connect either the readout line or the control circuit to an output terminal thereof based on a selection signal; and
an analog-to-digital converter electrically connected to the output terminal of the multiplexer,
wherein the control circuit comprises:
an operational amplifier connected between the readout line and the multiplexer;
a plurality of switching elements connected to a first input terminal of the operational amplifier;
a sampling capacitor connected to the first input terminal through one of the plurality of switching elements; and
a feedback resistor connected to the first input terminal through another one of the plurality of switching elements.

2. The data driving circuit of claim 1, wherein the plurality of switching elements comprise a first switching element connected between the readout line and a first node, and the multiplexer is configured to electrically connect the readout line to the analog-to-digital converter when the first switching element is turned off.

3. The data driving circuit of claim 2, wherein the plurality of switching elements comprise:
a second switching element connected between the first node and an output terminal of the operational amplifier;
a third switching element connected between the first node and the feedback resistor; and
a sixth switching element connected between the first node and the first input terminal,
wherein the feedback resistor is connected between the third switching element and the output terminal of the operational amplifier.

4. The data driving circuit of claim 3, wherein the plurality of switching elements further comprise a fourth switching element connected between a second node and the output terminal of the operational amplifier, and the sampling capacitor is connected between the first node and the second node.

5. The data driving circuit of claim 4, wherein the plurality of switching elements further comprise a fifth switching element connected between the second node and the first input terminal.

6. The data driving circuit of claim 1, wherein the operational amplifier comprises a second input terminal configured to receive a control circuit reference voltage.

7. The data driving circuit of claim 1, further comprising:
an initialization switch connected between the readout line and a reference voltage; and
a sampling switch connected between the readout line, the control circuit, and the multiplexer.

8. A method for driving a data driving circuit, the data driving circuit including a sensing node, an initialization switch, a sampling switch, a first switching element, and a multiplexer, the method comprising:
operating the data driving circuit in a first mode to sense a voltage value of the sensing node, wherein the first mode includes:
turning on the initialization switch during a first period;
turning off the initialization switch during a second period subsequent to the first period; and
turning on the sampling switch during a third period subsequent to the second period,
wherein, during the first period, the second period, and the third period, the first switching element is turned off, and a first level of a selection signal is applied to the multiplexer.

9. The method of claim 8, further comprising operating the data driving circuit in a second mode to sense a current value of the sensing node,
wherein the second mode includes:
turning on a second switching element during a first period of the second mode; and
turning off the second switching element during a second period subsequent to the first period of the second mode,
wherein, during the first period and the second period of the second mode, the sampling switch, the first switching element, a third switching element, and a sixth switching element are turned on, and a second level of the selection signal, different from the first level, is applied to the multiplexer.

10. The method of claim 8, further comprising operating the data driving circuit in a third mode to sense a current value of the sensing node, wherein the third mode includes:
turning on the first switching element and a second switching element during a first period of the third mode;
turning off the second switching element during a second period subsequent to the first period of the third mode; and
turning off the first switching element during a third period subsequent to the second period of the third mode,
wherein, during the first period, the second period, and the third period of the third mode, the sampling switch, a fourth switching element, and a sixth switching element are turned on, and a second level of the selection signal, different from the first level, is applied to the multiplexer.

11. The method of claim 8, further comprising operating the data driving circuit in a fourth mode to sense a voltage value of the sensing node, wherein the fourth mode includes:
turning on the initialization switch, the sampling switch, the first switching element, and a fourth switching element during a first period of the fourth mode;
turning off the initialization switch during a second period subsequent to the first period of the fourth mode; and
turning off the first switching element and the fourth switching element and turning on a second switching element during a third period following the second period of the fourth mode,
wherein, during the first period, the second period, and the third period of the fourth mode, a fifth switching element is turned on, and the first level of the selection signal is applied to the multiplexer.

12. A display device comprising:
a display panel comprising a plurality of pixels arranged therein;
a data driving circuit configured to apply a data voltage to the pixels; and
a timing controller configured to control operation timing of the data driving circuit,
wherein the data driving circuit comprises:
a control circuit electrically connected to a sensing node in a corresponding pixel through a readout line;
a multiplexer comprising an input terminal connected to the readout line and the control circuit, and configured to electrically connect either the readout line or the control circuit to an output terminal thereof based on a selection signal; and
an analog-to-digital converter electrically connected to the output terminal of the multiplexer,
wherein the timing controller is configured to apply a control signal to the data driving circuit to initiate a sensing mode of sensing characteristic values of the pixels, and the control circuit comprises an operational amplifier configured to operate differently based on the control signal.

13. The display device of claim 12, wherein the control circuit comprises:
the operational amplifier connected between the readout line and the multiplexer;
a plurality of switching elements connected to a first input terminal of the operational amplifier;
a sampling capacitor connected to the first input terminal through one of the plurality of switching elements; and
a feedback resistor connected to the first input terminal through another one of the plurality of switching elements.

14. The display device of claim 13, wherein the plurality of switching elements comprise a first switching element connected between the readout line and a first node, and the multiplexer is configured to electrically connect the readout line to the analog-to-digital converter when the first switching element is turned off.

15. The display device of claim 14, wherein the plurality of switching elements further comprise: a second switching element connected between the first node and an output terminal of the operational amplifier; a third switching element connected between the first node and the feedback resistor; and a sixth switching element connected between the first node and the first input terminal, wherein the feedback resistor is connected between the third switching element and the output terminal of the operational amplifier.

16. The display device of claim 15, wherein the plurality of switching elements further comprise a fourth switching element connected between a second node and the output terminal of the operational amplifier, and the sampling capacitor is connected between the first node and the second node.

17. The display device of claim 16, wherein the plurality of switching elements further comprise a fifth switching element connected between the second node and the first input terminal.

18. The display device of claim 13, wherein the operational amplifier comprises a second input terminal configured to receive a control circuit reference voltage.

19. The display device of claim 13, wherein the data driving circuit comprises:
an initialization switch connected between the readout line and a reference voltage; and
a sampling switch connected between the readout line, the control circuit, and the multiplexer.

20. The display device of claim 12, wherein the timing controller comprises:
a compensation unit that determines and generates compensation values for the characteristic values of the pixels, based on sensing data obtained through sensing the pixels; and
a memory that stores the compensation values generated by the compensation unit.
